(19) United States
(12) Patent Application Publication
(10) Pub. No.: US 2014/0110494 A1
(43) Pub. Date: Apr. 24, 2014

(54) WAVE ELECTRO-HYDRODYNAMIC DEVICE

(71) Applicant: Accio Energy, Inc., Ann Arbor, MI (US)

(72) Inventors: Francis Mills, Ann Arbor, MI (US); Dawn White, Ann Arbor, MI (US); David Carmein, Ann Arbor, MI (US)

(73) Assignee: Accio Energy, Inc., Ann Arbor, MI (US)

(21) Appl. No.: 14/138,677

(22) Filed: Dec. 23, 2013

Related U.S. Application Data
(63) Continuation-in-part of application No. 13/264,306, filed on Dec. 23, 2011.
(60) Provisional application No. 61/782,280, filed on Mar. 14, 2013.

(51) Int. Cl. B05B 5/025

(52) U.S. Cl. CPC B05B 5/025
USPC 239/3; 239/690

(57) ABSTRACT

A system for energy extraction from a fluid stream including a wave pump configured to pump a volume of liquid from a liquid source in response to wave motion of the liquid source; a charge source, fluidly connected to the volume of fluid, that emits a charged droplet of the volume of fluid into the fluid stream, the charged droplet having a first polarity; and an electrical isolation mechanism configured to selectively electrically isolate the charge source from the wave pump.

### CROSS-REFERENCE TO RELATED APPLICATIONS

This application is a continuation-in-part of U.S. application Ser. No. 13/264,306 filed 23 Dec. 2011, which are incorporated in its entirety by this reference. This application claims the benefit of US Provisional Application No. 61/782,280 filed 14 Mar. 2013, which is incorporated in its entirety by this reference.

### TECHNICAL FIELD

This invention relates generally to the energy generation field, and more specifically to a new and useful electro-hydrodynamic system in the energy generation field.

### BACKGROUND

Electro-hydrodynamic (“EHD”) energy conversion is a process wherein electrical energy is extracted from the kinetic energy of a flowing fluid, such as a wind stream. An EHD system emits a fine mist of charged particles of a single polarity into a wind stream, wherein the wind stream separates the charges from the oppositely charged source. Subsequent collection and combination of the charges on the charged particles with opposing charges results in charge flow, thereby resulting in electrical power. However, conventional EHD systems, in particular land-bound EHD systems, suffer from several disadvantages. First, conventional EHD systems must either carry an energy storage device on-board or be tethered to a power grid for the purposes of powering the particle charging device. Second, as liquid is commonly used as the charged particle, conventional EHD systems must retain or have a fluid connection to a large volume of liquid that must be periodically refilled if continuous EHD system operation is desired. Both of these disadvantages require active monitoring by an operator.

Thus, there is a need in the electro-hydrodynamic field to create a new and useful electro-hydrodynamic system that can be passively operated. This invention provides such new and useful electro-hydrodynamic system.

### BRIEF DESCRIPTION OF THE figures

FIG. 1 is a schematic representation of a variation of the wave electrohydrodynamic system in operation.

FIG. 2 is a schematic representation of a variation of the wave electrohydrodynamic system including a variation of the electric isolation mechanism.

FIG. 3 is a schematic representation of a variation of the wave electrohydrodynamic system with the EHD device located on a tethered wave power device, a load connected to shore, and a component downstream collector.

FIG. 4 is a schematic representation of a variation of the wave electrohydrodynamic system with the EHD device located on a wave power device mounted to the floor of the liquid source and a load with an exposed second terminal, wherein the liquid source functions as the downstream collector.

FIG. 5 is a schematic representation of a variation of the wave electrohydrodynamic system with a reservoir positioned above the EHD device.

FIG. 6 is a schematic representation of a variation of the wave electrohydrodynamic system with reservoirs located the same distance away from the charge source.

FIG. 7 is a schematic representation of a variation of the wave electrohydrodynamic system with reservoirs located different distances away from the charge source.

FIG. 8 is a schematic representation of a variation of the wave electrohydrodynamic system with multiple wave power devices fluidly connected to an EHD device.

FIG. 9 is a schematic representation of a variation of the wave electrohydrodynamic system with a wave power device fluidly connected to multiple EHD devices.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

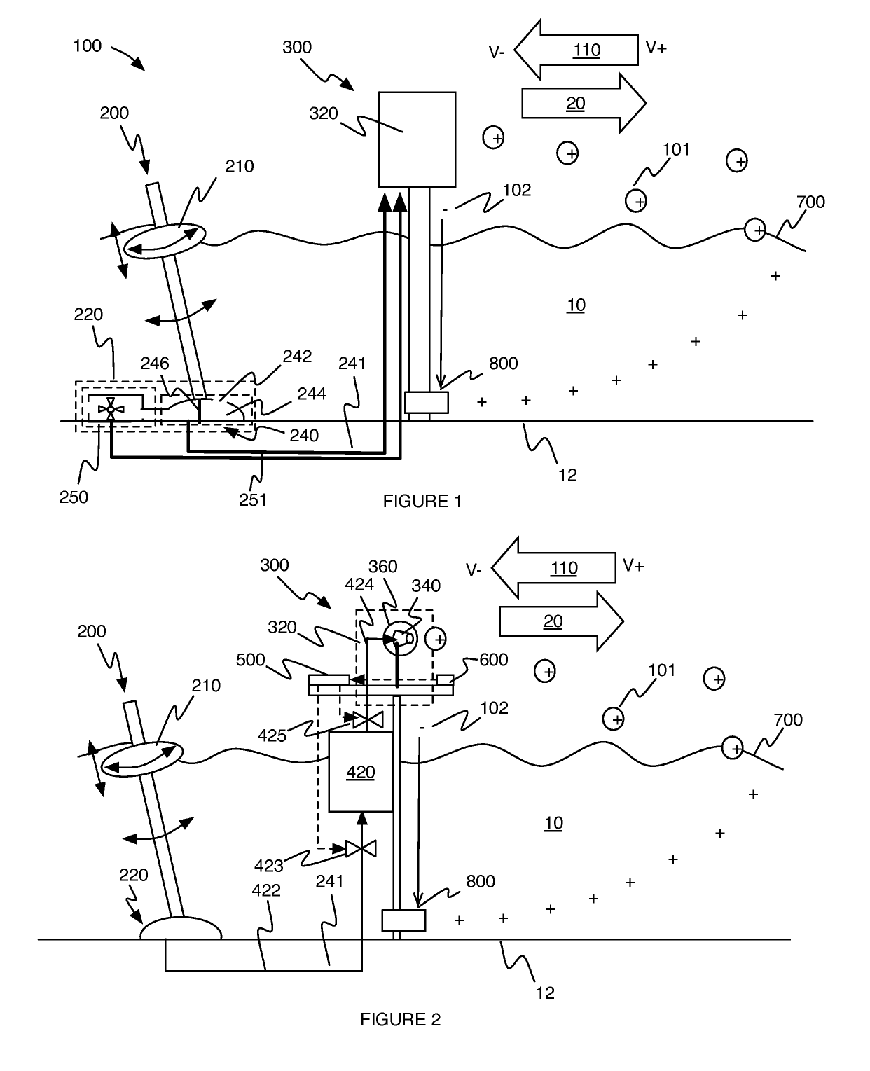

As shown in FIGS. 1 and 2, the wave electro-hydrodynamic system (wave EHD system) 100 includes a wave power device 200, an EHD device 300, and an electric isolation mechanism 400 between the wave power device 200 and the EHD device 300. The wave EHD system 100 preferably functions to convert wind energy into electrical energy by using wave power to pump and/or power the EHD device 300.

The wave EHD system 100 is preferably used in wave applications such as offshore applications, but can be used in any other suitable application with liquid waves. The wave EHD system 100 is preferably placed in or on a liquid source 10, wherein wave movement over the surface of the liquid source 10 facilitates wave EHD system 100 operation. The liquid source 10 is preferably the ocean, a lake, a run-of-the-river pump, but can alternatively be any other suitable liquid source 10. The liquid of the liquid source 10 is preferably charging liquid, wherein the EHD device 300 is capable of using the charging liquid for charged particles. The charging liquid is preferably electrically conductive, but can alternatively be electrically non-conductive and include electrically conductive particulates (e.g., additives such as salt, etc.). The liquid of the liquid source 10 can alternatively be a separate liquid (e.g., water condensed from the atmosphere), a precursor of the charging liquid (e.g., a reagent required to make the charging liquid), or any other suitable liquid.

By coupling the EHD device 300 to a wave power device 200, the wave EHD system 100 confers several benefits over conventional, land-bound EHD systems. First, the wave EHD system 100 can leverage wave power to pump a charging liquid to the charge source 320. Wave power can additionally be used to power the charge source 320, thereby removing the requirement for an auxiliary power source to power the EHD device 300. Second, the wave EHD system 100 can be used in offshore applications with higher wind speeds than land applications, thereby resulting in potentially higher amounts of harvested electricity.

The wave power device 200 preferably includes a wave member 210 connected to an energy extraction mechanism. The wave power device 200 (e.g., wave pump) of the wave EHD system 100 functions to pump charging liquid to the EHD device 300 for charging and emission. The wave power device 200 can additionally function to provide electric energy to the EHD device 300 for charging the charging liquid. The wave power device 200 can additionally function to pressurize the charging liquid. The wave power device 200 preferably harnesses motion of the liquid source 10 to pump and/or harvest electric power. The motion of the liquid source 10 is preferably motion on the liquid source 10 (e.g., wave motion), but can alternatively be motion in the liquid source 10 (e.g., currents), or any other suitable motion of the liquid source 10. The wave power device 200 is preferably operable in a single mode (e.g., always extracting energy), but can alternatively be operable between a standby mode and an extracting mode. In the standby mode, the energy extraction from liquid motion (e.g., pumping or electric power extraction) is preferably halted. The wave power device 200 preferably fluidly isolates a volume of fluid proximal the EHD device 300 from the liquid source 10 in the standby mode, but can alternatively fluidly connect the volume of fluid proximal the EHD device 300 with the liquid source 10 in the standby mode. In the extracting mode (e.g., harvesting mode), energy is preferably extracted from liquid motion. Wave power device operation can be controlled by selectively halting reciprocating member translation (e.g., seizing the reciprocating member within the pump), selectively connecting and disconnecting the wave member 210 from the energy extractor 220, or selectively pressurizing an energy extractor 220 chamber, or otherwise selectively halting wave power device operation.

The wave member 210 of the wave power device 200 functions to moves with motion of the liquid within the liquid source 10, and mechanically couples liquid motion to the energy extractor 220. The wave member 210 is preferably buoyant, such that the wave member 210 is suspended on the surface of the liquid source 10 or submerged within the liquid, but can alternatively be any suitable member that moves with the liquid. The wave member 210 can rotate with the liquid (e.g., with a wave), translate longitudinally with the liquid (e.g., move vertically with a wave relative to a gravity vector), and/or translate laterally with the liquid (e.g., along the surface of the liquid source 10). The wave member 210 is preferably configured to be oriented with a longitudinal axis parallel to a gravity vector, but can alternatively be oriented with a longitudinal axis perpendicular or at an angle to the gravity vector. The wave member 210 can include a buoy, point absorber, surface-following attenuator oriented parallel to the direction of wave propagation, terminator oriented perpendicular to the direction of wave propagation, oscillating water column, or overtopping. The wave member 210 or wave power device 200 can additionally include parabolic reflectors to increase wave energy at the point of wave capture.

The energy extractor 220 of the wave power device 200 functions to convert liquid motion into mechanical and/or electrical energy. The energy extractor 220 is preferably mechanically connected to the wave member 210 by a tether, pole, or any other suitable mechanical connection. The energy extractor 220 can additionally be fluidly connected to the wave member 210. The energy extractor 220 is preferably substantially permanently connected to the wave member 210, but can alternatively be transiently (e.g., removably or selectively) connected to the wave member 210. In the variation in which the energy extractor 220 can be decoupled from the wave member 210, the connection state between the energy extractor 220 and the wave member 210 is preferably actively controlled by a controller 500 (e.g., a processor), but can alternatively be passively controlled (e.g., in response to pressure or liquid level within a reservoir 420 surpassing a threshold).

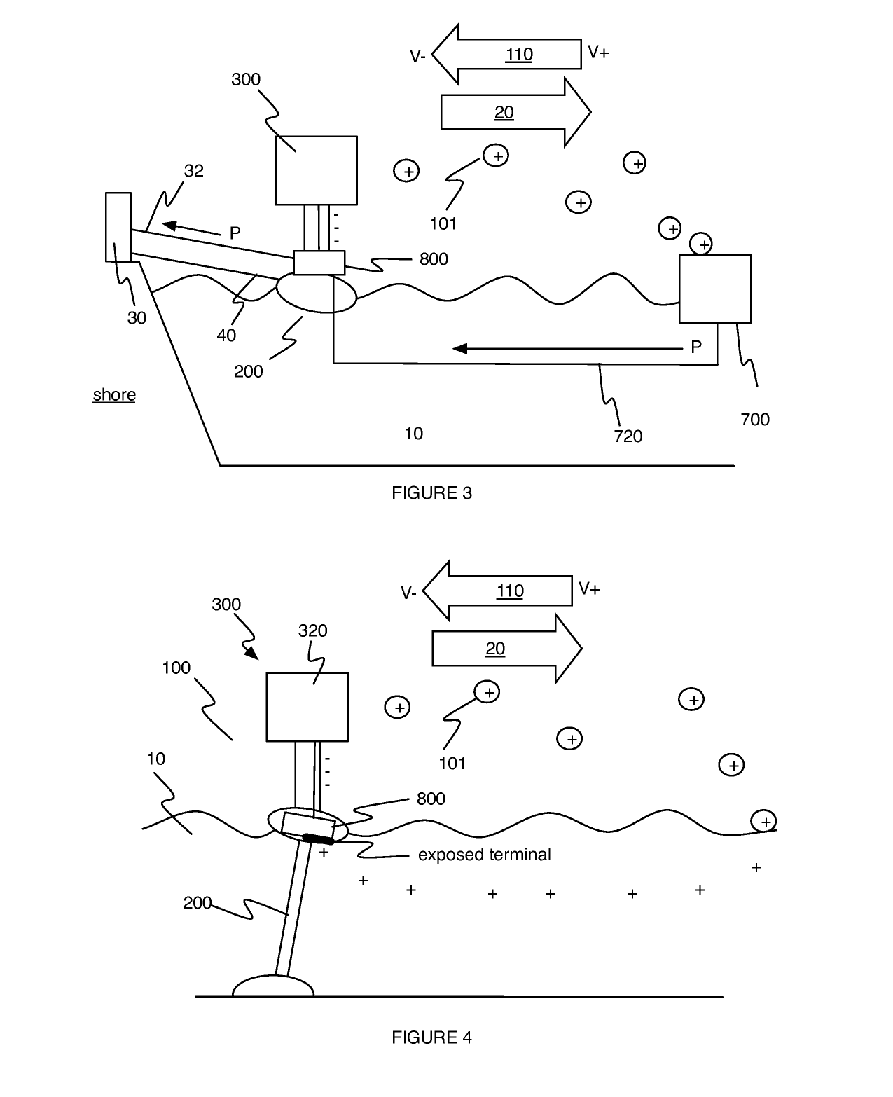

The energy extractor 220 preferably includes a mechanical energy extractor 240 (e.g., fluid pump), more preferably a liquid pump, which is configured to pump a volume of liquid from the liquid source 10. The pumped volume of liquid is preferably provided to the EHD device 300, wherein the EHD device 300 generates charged droplets from the pumped liquid volume 241. Alternatively, the pumped volume of liquid can be provided to an electric energy extractor 250, wherein the electric energy extractor 250 extracts electric energy from the pumped liquid volume 241. The pump can include an inlet 242 fluidly connected to the liquid source 10, a chamber 244 fluidly connected to the inlet (e.g., defined by a housing), and a pumping mechanism 246 (e.g., reciprocating member) that pumps fluid within the wave power device 200. The pumping mechanism is preferably a positive displacement pump, and can be a reciprocating pump, piston pump, vane pump, diaphragm pump, peristaltic pump, or any other suitable pump. Alternatively, other pump types, such as turbines, centrifugal pump devices, gravity pumps, eductor-jet pumps, or any other suitable pump mechanism can be used. The pump mechanism can include one or more different pump types, wherein different buoy movement can be coupled to different pumps. The chamber is preferably selectively fluidly connected to the EHD device 300 (e.g., as described above), preferably to the charge source 320, more preferably to a reservoir 420 of an electric isolation mechanism 400. The wave member 210 preferably engenders relative motion between the chamber and pumping mechanism, and can be connected to the chamber (e.g., wherein the pumping mechanism is statically connected to the floor 12 of the liquid source 10, such as the seabed, to a structure that is substantially static relative to the seabed, such as a pier, shipwreck, monopole, anchors, jetty, etc., to a pre-existing buoy, or to shore) or be connected to the pumping mechanism (e.g., wherein the chamber member is statically connected to the floor 12 of the liquid source 10 or to shore). The wave member 210 is preferably connected to the pumping mechanism or chamber by a rigid connection but can alternatively be connected by a flexible connection. An energy extractor 220 component, preferably the chamber but alternatively the pumping mechanism, is preferably anchored to a floor 12 of the liquid source 10 (e.g., seabed), but can alternatively be free-floating and tethered to a stationary point relative to the liquid source 10 floor 12 (e.g., tethered to shore, as shown in FIG. 3).

The pump can be operable between a pumping mode and a standby mode. The pump can additionally or alternatively be operable in a power supply mode. In the pumping mode, the pump is preferably pumping liquid from the liquid source 10 to the EHD device 300. In the standby mode, the pump is preferably seized or not pumping. In the power supply mode, the pump is preferably pumping liquid from the fluid source to the electric energy extractor 250. For example, in a wave power device 200 including a pumping chamber and a turbine, the wave power device 200 can be selectively operated in the pumping mode, wherein the pumped liquid 241 in the pumping chamber is provided through a first manifold to the EHD device 300 or intermediary liquid reservoir 420, and the power supply mode, wherein the pumped liquid 241 is directed toward the turbine through a second manifold, which extracts electrical power from the pumped liquid 241. The pumping mode and the power supply mode are preferably mutually exclusive, but the wave power device 200 can alternatively be simultaneously operated in the pumping mode and the power supply mode (e.g., wherein the pumped liquid 241 is divided between the two manifolds).

As shown in FIG. 1, the energy extractor 220 can additionally or alternatively include an electric energy extractor 250 (e.g., power take-off system) that converts liquid motion into electric power. In this variation, the wave power device 200 can be electrically connected to the charge source 320 or charging mechanism 360 of the EHD device 300, wherein the extracted electric power 251 can subsequently used to power the EHD device 300 (e.g., charge the droplets, power the sensors 600 and controller 500, etc.). The power take-off system can include one or more piezoelectrics, hydraulic rams, elastomeric hose pumps, hydroelectric turbine, air turbine, linear electrical generator, or any other suitable power take-off system. The power take-off system is preferably fluidly connected to the mechanical energy extractor 240 and extract energy from the liquid pumped by the mechanical energy extractor 240. Alternatively, the power take-off system can be independent of the mechanical energy extractor 240, such as in the case of an overtopping system.

The wave EHD system 100 preferably includes a single wave power device 200, but can alternatively include multiple wave power devices. The multiple wave power devices preferably include at least one wave power device that pumps fluid to the EHD device 300, wherein the remainder of wave power devices can all be power-generating wave power devices, fluid-pumping wave power devices, or a combination of power-generating and fluid-pumping wave power devices. Alternatively, each wave power device 200 can simultaneously pump fluid to the EHD device 300 and provide power to the EHD device 300. Alternatively, each wave power device 200 can alternate between pumping fluid to the EHD device 300 and providing power to the EHD device 300 (e.g., wherein wave power devices that are not pumping fluid to the EHD device 300 are extracting electric power that is stored in a battery or supplied to the grid). Multiple fluid-pumping wave power devices can be fluidly connected in series or in parallel. Multiple power-generating wave power devices can be electrically connected in series or in parallel.

As shown in FIG. 1, the electro-hydrodynamic device (EHD device 300) of the wave EHD system 100 functions to extract electric power from wind. In operation, the EHD device 300 emits or injects a charged particle 101 of a first polarity into the wind against an electric field 110 induced by the EHD device 300. The wind preferably moves the charged particle 101 against the electric field 110 (e.g., drag force of the wind on the particle opposes the drag force of the electric field on the particle). Subsequent collection and recombination of the charged particle 101 with a charge having an opposing polarity at a load 800 of the EHD device 300 extracts electric power from the wind. The EHD device 300 preferably emits multiple charged particles of the same polarity, but can alternatively emit multiple charged particles of a first and second polarity (e.g., both positive and negative particles), wherein the ratio of first to second polarity particles can be controlled to manage the space charge generated proximal the EHD device 300.

The EHD device 300 is preferably operable between an operating mode and a standby mode, but can alternatively be operable between any other suitable modes. In the operating mode, the EHD device 300 is preferably generating, charging, and emitting droplets into the fluid stream 20 (e.g., wind). In the standby mode, the EHD device 300 is preferably not charging the droplets, and can additionally cease droplet generation and introduction into the fluid stream 20. The EHD device operation modes are preferably controlled by a controller 500, but can alternatively be controlled by any other suitable mechanism. The EHD device operation mode can be controlled based on ambient environmental parameter measurements (e.g., in the operating mode in response to the wind speed exceeding a threshold speed, in the standby mode in response to the wind speed falling below a second threshold speed), signals received from the power grid 30 to which the EHD device 300 is electrically connected (e.g., in the operating mode in response to receipt of a power harvesting signal, in the standby mode in response to receipt of a halt signal), based on the liquid or electric energy requirements of the EHD device 300, or based on any other suitable EHD device 300 control event.

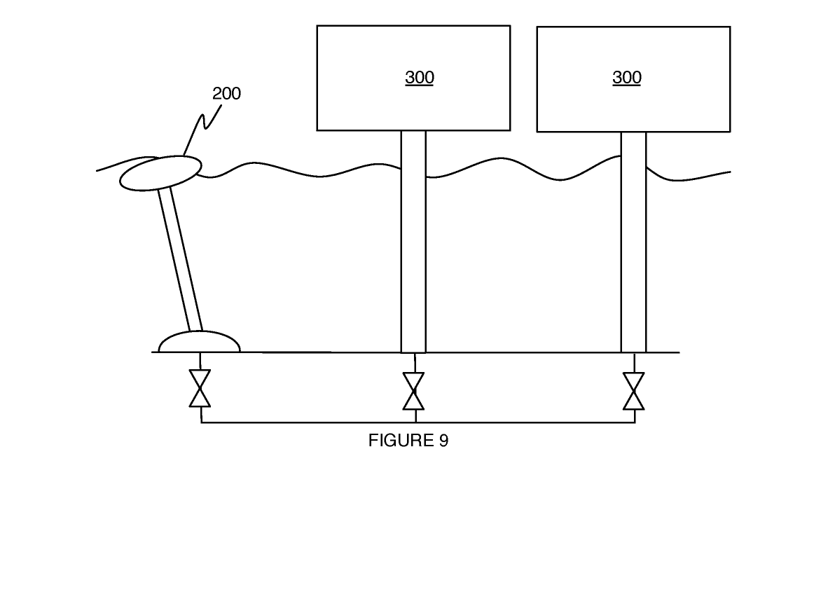

The EHD device 300, more preferably the charge source 320 but alternatively other EHD device 300 component, is preferably electrically isolated or insulated from the liquid source 10. The EHD device 300, more preferably the charge source 320 but alternatively any other EHD device 300 component, is preferably maintained above the surface of the liquid source 10, but can alternatively be maintained substantially level with the surface of the liquid source 10 or below the liquid source 10 surface. The EHD device 300 is preferably located on a component of the wave power device 200, preferably on the wave member 210 (e.g., the buoy or point absorber) as shown in FIGS. 3 and 4, but the EHD device 300 can alternatively be located on another wave power device component, such as the chamber. The EHD device 300 can alternatively be substantially separate from the wave power device, wherein the EHD device 300 can be mounted to a separate buoy, a support structure anchored or tethered to the floor 12 of the liquid source 10 (e.g., as shown in FIG. 1), a support structure on the shore (e.g., wherein the wave power device pumps liquid to shore), or any other suitable support structure. The support structure preferably maintains the distance between electrical ground (e.g., the ground, the surface of the liquid, a conductive element electrically connected to electrical ground, etc.) and the EHD device 300 at approximately eight times the maximum dimension of the largest charged component in the EHD device 300 (e.g., as described in U.S. application Ser. No. 13/632,974, filed 1 Oct. 2012, incorporated herein in its entirety by this reference). However, the support structure can alternatively hold the EHD device 300 at any suitable distance relative to electrical ground. The height or distance of the support structure is preferably adjustable, but can alternatively be fixed. The height or distance of the support structure is preferably adjusted to maximize EHD performance (e.g., to maximize EHD power output, based on the current output or EHD voltage), but can alternatively be adjusted based on environmental parameters (e.g., wind speed, humidity, etc.), or based on any other suitable parameter. The wave EHD system 100 can include one or more EHD devices 300. Multiple EHD systems are preferably electrically connected in parallel, but can alternatively be electrically connected in series. Each EHD device 300 can be coupled to one or more wave power devices, as shown in FIG. 8. Alternatively, multiple EHD devices 300 can be coupled to a single wave power device 200, as shown in FIG. 9. However, the wave EHD system 100 can have any other suitable configuration.

The EHD device 300 preferably includes a charge source 320 (e.g., emitter) that functions to emit and/or generate charged particles. The charged particles are preferably of a single polarity, wherein charges of the opposite polarity (collected charges) are preferably retained by the charge source 320. The charged particles can be positively charged, wherein the collected charges are negative charges. Alternatively, the charged particles can be negatively charged, wherein the collected charges are positive charges. The charged particles are preferably liquid droplets, but can alternatively be ambient charge carriers (e.g., water vapor clusters, sheared water particles, etc.), solid particulates such as salt or microorganisms, or any other suitable charge carrier. The charged particles are preferably extracted from the liquid source 10 (e.g., the ocean), but can alternatively be extracted from the environment (e.g., air) above the liquid source 10. The charge source 320 is preferably powered by energy harvested by the wave power device 200, but can alternatively be powered by an on-board energy storage device that stores energy harvested by the wave power device 200 or energy harvested by the EHD device 300, by a connection to an on-shore power grid 30, or by any other suitable power source.

The charge source 320 preferably includes an injector configured to emit a particle into a wind stream. The injector is preferably a droplet generator 340 that functions to generate a droplet of liquid from a volume of liquid, but can alternatively be any other suitable injector. The volume of liquid is preferably the liquid pumped by the wave power device 200 from the liquid source 10, but can alternatively be a separate volume of liquid retained by a separate liquid reservoir 420. The charge source 320 can additionally include a charging mechanism 360 (e.g., droplet charger) that functions to charge the droplet of liquid, and can additionally function to generate a first electric field. The charging mechanism 360 is preferably an electrode, but can alternatively be a corona discharge device, dielectric discharge device, or any other suitable mechanism capable of imparting a charge on the particle (e.g., droplet). The electrode voltage is preferably adjusted or otherwise controlled to control the charge imparted on the droplets (e.g., by a controller 500). The charging mechanism 360 can be powered by electric power generated by the wave power device 200 (e.g., directly from the wave power device 200 or though a power storage mechanism, such as a battery), powered by an on-shore grid, powered by energy generated by the EHD device 300, powered by energy generated by another energy harvesting mechanism (e.g., wind, solar, etc.), or powered in any other suitable manner. The charge source 320 preferably generates droplets that are charged to less than the Rayleigh limit (e.g., to less than 10%, 25%, 50%, 75%, 100% of the Rayleigh limit), but can alternatively be charged to the Rayleigh limit.

The charge source 320 is preferably one of those described in U.S. application Ser. No. 12/357,862 or PCT application PCT/US09/31682, incorporated herein in their entirety by this reference. However, the charge source 320 can be any other suitable system capable of emitting charged particles into a fluid stream 20 (e.g., wind stream).

In a first variation of the charge source 320, the droplet generator 340 and charging mechanism 360 cooperatively form the charged droplets. The droplet generator 340 can be configured to expose a small volume of the liquid to the charging mechanism 360, wherein the electric field generated by the charging mechanism 360 deforms the small volume of liquid to form the droplet. The droplet generator 340 and charging mechanism 360 preferably cooperatively form a Taylor cone that disperses into droplets, but can alternatively cooperatively form the droplets in any other suitable manner. The droplet generator 340 can be a nozzle, an orifice in a surface, a flat surface, a vibrating surface, or any other suitable mechanism that exposes a small volume of the liquid to the charging mechanism 360 (e.g., that exposes a controlled volume of the liquid to the charging mechanism 360). The charging mechanism 360 is preferably an electrode, such as a ring electrode surrounding and/or coaxial with the droplet generator 340, a bar electrode, a plate electrode, or any other suitable electrode.

In a second variation of the charge source 320, the droplet generator 340 generates droplets and the charging mechanism 360 charges the droplets after the droplet is formed. The droplet generator 340 can form the droplet through mechanical or chemical mechanisms. Examples of droplet generator 340s that can be used include nozzles, orifices, vibration mechanisms, superhydrophobic materials, or any other suitable mechanism capable of forming droplets within substantially uniform distribution of sizes. The charging mechanism 360 preferably applies an electric field downstream from the droplet generator 340 (e.g., distal the liquid feed to the droplet generator 340, proximal the droplet generator 340 outlet, etc.), but can alternatively apply an electric field to the droplet generator 340 outlet, the liquid source 10, or to any other suitable component of the droplet generator 340. However, any other suitable charge source 320 capable of generating charged droplets can be used.

The EHD device 300 preferably includes an array of charge source 320s, but can alternatively include a single charge source 320, a plurality of charge source 320s arranged in a line, or any other suitable number of charge source 320s arranged in any suitable configuration. However, the charge source 320 can be any suitable source of charged particles.

In one example of the EHD device 300, the charge source 320 includes one or more point sources. In one alternative of the EHD device 300, the point source includes an arrangement of electrospray injectors. In another alternative of the EHD device 300, the point source includes a plurality of charging electrodes, each coupled to a spray nozzle, wherein the spray nozzle can be a plain orifice nozzle, swirl nozzle, compound nozzle, two-fluid nozzle, or any other suitable nozzle. The charging electrode can be a ring electrode concentric with the nozzle, a rail electrode proximal the nozzle (e.g., above, below, up or downstream from the nozzle), a bar electrode proximal the nozzle (e.g., upstream from the nozzle) or any other suitable charging electrode. In a third alternative of the EHD device 300, the point source is a MEMS-based inkjet and electrospray combination.

In a second example of the EHD device 300, the charge source 320 includes a reservoir 420 of charging liquid and an electrode disposed above the reservoir 420, wherein the electrode charges and pulls liquid droplets from the reservoir 420 surface. Alternatively, the charge source 320 can include an electrode disposed over the liquid source 10, wherein the electrode charges and pulls liquid droplets directly from the liquid source 10. In a third example, the charge source 320 is a corona discharge device that charges the charging liquid within the reservoir 420. In a fourth example, the charge source 320 is a dielectric discharge device that charges the charging liquid within the reservoir 420. However, any other suitable charge source 320 can be utilized.

The EHD device 300 can additionally include or leverage a downstream collector 700 that functions to collect the charged particles released by the charge source 320. The downstream collector 700 is preferably electrically connected to the charge source 320, preferably through the load 800 but alternatively through other means. The downstream collector 700 is preferably electrical ground, but can alternatively have the same polarity of the charged particles, preferably with a polarity opposite that of the charge source 320. As shown in FIG. 1, the downstream collector 700 is preferably a portion of the liquid source 10 downstream from the charge source 320 along the wind stream, but can alternatively be a component of the EHD device 300, as shown in FIG. 3. When the downstream collector 700 is a component, the downstream collector 700 is preferably conductive and electrically connected to the EHD device 300 through a power cable 720. Examples of component downstream collectors 700 include a grid, a mesh, a wire, a plate, a conductive object such as an ellipsoid, or a conductive linear hollow member with an airfoil cross section, but any other suitable downstream collector 700 can be used. The downstream collector 700 is preferably statically grounded, or can be intermittently electrically connected to either the EHD device 300 or to the ground. The downstream collector 700 is preferably free-floating and tethered to the EHD device 300, but can alternatively be mounted to the floor 12 of the liquid source 10, mounted to the shore, or otherwise restrained relative to the EHD device 300. The downstream collector 700 can additionally include an orientation device (e.g., a sail or motor) that maintains the position of the downstream collector 700 at a point downstream from the EHD device 300 along the wind stream.

The EHD device 300 can additionally include a field shaper, which controls the electric field in the substantially immediate downwind vicinity of the charge source 320. The field shaper is preferably the system disclosed in prior application Ser. No. 13/276,055, filed 18 Oct. 2011 and titled “System And Method For Controlling Electric Fields In Electro-Hydrodynamic Applications,” incorporated herein in its entirety by this reference, but can alternatively be any suitable field shaper. The field shaper is preferably an electric field generator that generates a third electric field in the immediate downwind vicinity of the charge source 320. This third field preferably opposes the system field 110, which tends to concentrate at the charge source 320. By applying an opposing third field near the charge source 320, the field shaper can reduce or substantially eliminate the effects of the space charge. The field shaper can be held at a potential substantially similar or equal to the system potential, or can be held at a different potential. The field shaper is preferably a structural component of the EHD device 300, and more preferably functions as the support structure, but can alternatively be a separate component. The EHD device 300 preferably includes a field shaper located proximal the charge source 320, but can alternatively/additionally include a field shaper located proximal the downstream collector 700 or proximal any other suitable charged EHD device 300 component. The field shaper can be statically grounded, or can be intermittently electrically connected to either the EHD device 300 or to the ground. However, the field shaper can be any suitable system or electrode that manages the magnitude of the system field. In one variation of the system, the field shaper includes a circumscribing, inductive ring with an open space defined within the center, wherein the charge source 320 is preferably located within the defined space. The circumscribing structure is preferably circular and/or toroidal, but can alternatively be a rectangular prism, polygonal prism (e.g., pentagonal, hexagonal, etc.), cylindrical, ovoid, or have any other suitable geometry.

In a second variation of the system, the field shaper includes an attracting electrode and a shielding electrode of opposite polarities. The attracting electrode preferably attracts the charged particles towards the field shaper, while the shielding electrode repels the charged particles and prevents the charged particles from shorting to the attracting electrode. In this variation, the adjustment element can control the distance between the attracting and shielding electrodes, the distance between electrode pairs, the height of the electrode pair relative to electrical ground (e.g., by controlling the height of the electrode pair relative to ground or by controlling the relative position of a grounded electrode to the electrode pair), control the potentials of the electrodes or control any other suitable field shaper parameter. Alternatively, any other suitable field shaper can be utilized.

As shown in FIG. 1, the EHD device 300 can additionally include a load 800 that functions to convert charge flow into electric power. The load 800 is preferably a resistive load 800, but can alternatively be any other suitable load 800. The load 800 can additionally be an energy storage device, wherein the load 800 further functions to store power generated by the EHD device 300 or the wave power device 200. However, the wave EHD system 100 can include one or more separate energy storage devices from the load 800. The load 800 can additionally power the charge source 320. The load 800 is preferably located on the EHD device support structure (e.g., within or on the buoy, on a platform supporting the EHD device 300, etc.) as shown in FIGS. 1, 2, and 3, but can alternatively be located distal the EHD device 300 (e.g., on shore), or within the liquid source 10 (e.g., mounted to the floor 12 of the liquid source 10).

The load Boo is preferably electrically connected to the charge source 320 at a first terminal and to the downstream collector 700 at a second terminal. The load 800 is preferably entirely fluidly insulated from the liquid source 10 except for the second terminal, which can be fluidly isolated or fluidly connected to the liquid source 10. The first terminal is preferably substantially fluidly and electrically isolated from the liquid of the liquid source 10. The first terminal is preferably connected to the charge source 320 by an electrical connection that extends through the body of the EHD device 300, but can alternatively be connected to the charge source 320 by an electrical connection external the EHD device 300 (e.g., a wire extending along the EHD device 300 exterior), particularly when the load 800 is distal from the charge source 320. The second terminal can be exposed to the liquid of the liquid source 10 as shown in FIG. 4, wherein the liquid source 10 functions both as the downstream collector 700 and as the electrical connection between the load 800 and the downstream collector 700. However, the second terminal can be substantially fluidly isolated from the liquid of the liquid source 10 as shown in FIG. 3, wherein a load 800 fluidly and electrically isolated from the charging liquid electrically connects the second terminal to a component downstream collector 700.

The load 800 preferably additionally includes a power output that permits power take-off. The power output is preferably substantially permanently electrically connected to the shore (e.g., to a power grid 30 on the shore) by a transmission power cable 32, as shown in FIG. 3. In this variation, the transmission power cable 32 can function as or be supported by a tether 40 that tethers the wave EHD system 100 to shore. Alternatively, the transmission power cable 32 can be separate from the EHD device support structure. The load 800 can alternatively transiently and/or removably connect to a secondary energy storage device, wherein the wave EHD system 100 is periodically brought to shore to connect to the secondary energy storage device.

As shown in FIG. 2, the electric isolation mechanism 400 of the wave electro-hydrodynamic system functions to facilitate liquid provision from the liquid source 10 to the EHD device 300 while electrically isolating the EHD device 300 from the liquid source 10 while the EHD device 300 is in operation (e.g., emitting charged particles). Electrical isolation between the liquid source 10 and the EHD device 300 can be desirable, as the EHD device 300 relies on the separation of charges to generate power. Electrical connection between the EHD device 300 and the liquid source 10 (e.g., electrical ground) during EHD system operation can result in an inability to build or sustain the requisite voltage (e.g., potential energy difference) between the EHD device 300 and electrical ground, leading to low or no power extraction. The electric isolation mechanism 400 preferably electrically isolates an EHD system from the liquid source 10 by fluidly isolating the fluid supply for the EHD device 300 from the liquid source 10. More preferably, the electric isolation mechanism 400 electrically isolates the EHD system from the liquid source 10 by inducing or otherwise introducing an air gap between the EHD system and the liquid source. However, the electric isolation mechanism 400 can otherwise electrically isolate the fluid supply for the EHD source from the liquid source 10. The electric isolation mechanism 400 can selectively apply the fluid disconnection at the EHD device 300 (e.g., at the fluid inlet to the charge source 320), across the fluid connection between the EHD device 300 and the wave power device 200, at the wave power device 200, between the wave power device 200 and the liquid source 10, or at any other suitable point along the fluid connection between the EHD device 300 (e.g., charge source 320) and liquid source 10.

The electric isolation mechanism 400 is preferably operable between a filling mode and a supply mode (e.g., depletion mode). The electric isolation mechanism 400 operation mode is preferably selected and controlled by a controller 500, but can alternatively be passively controlled (e.g., based on pressure) or otherwise controlled. In the filling mode, liquid from the liquid source 10 is preferably pumped or otherwise provided to the EHD device 300 or an intermediary liquid source 10 configured to supply the EHD device 300. In the supply mode, the pumped liquid 241 is preferably consumed by the EHD device 300 during charged particle 101 generation The electric isolation mechanism 400 is preferably operated in the filling mode in response to detection of a fill event (e.g., pumping event). The fill event can be the liquid level within the reservoir 420 dropping below a first threshold level, the EHD device 300 shutting off, a measurement of a system parameter falling or exceeding a threshold level (e.g., the wind speed falling below a threshold velocity), or any other suitable event in which reservoir 420 refilling can be desirable. The controller 500 preferably operates the system or system components in the supply mode in response to detection of a supply event. The supply event can be an event that indicates that power production from the EHD device 300 is desirable, or can be any other suitable event that indicates that the EHD device 300 should be connected to a given reservoir 420. The supply event can be the liquid level within the reservoir 420 exceeding a second threshold level (e.g., different from the first threshold level, same as the first threshold level), the EHD device 300 turning on, the wind speed exceeding a threshold velocity, the wave pumping frequency or speed falling below a threshold level, or any other suitable event. However, the controller 500 can alternatively control the reservoir 420, EHD device 300, and/or wave power device 200 to operate in any other suitable mode based on any other suitable parameter measurement or event.

The EHD device 300 can operate in the operating mode throughout electric isolation mechanism operation in the filling and supply modes. Alternatively, the electric isolation mechanism 400 can be operated in the filling mode when the EHD device 300 is in the standby mode, and can be operated in the supply mode when the EHD device 300 is in the operating mode. The electric isolation mechanism 400 mode is preferably selected in response to the EHD device 300 operating mode, but the EHD device 300 operating mode can alternatively be selected based on the electric isolation mechanism 400 mode.

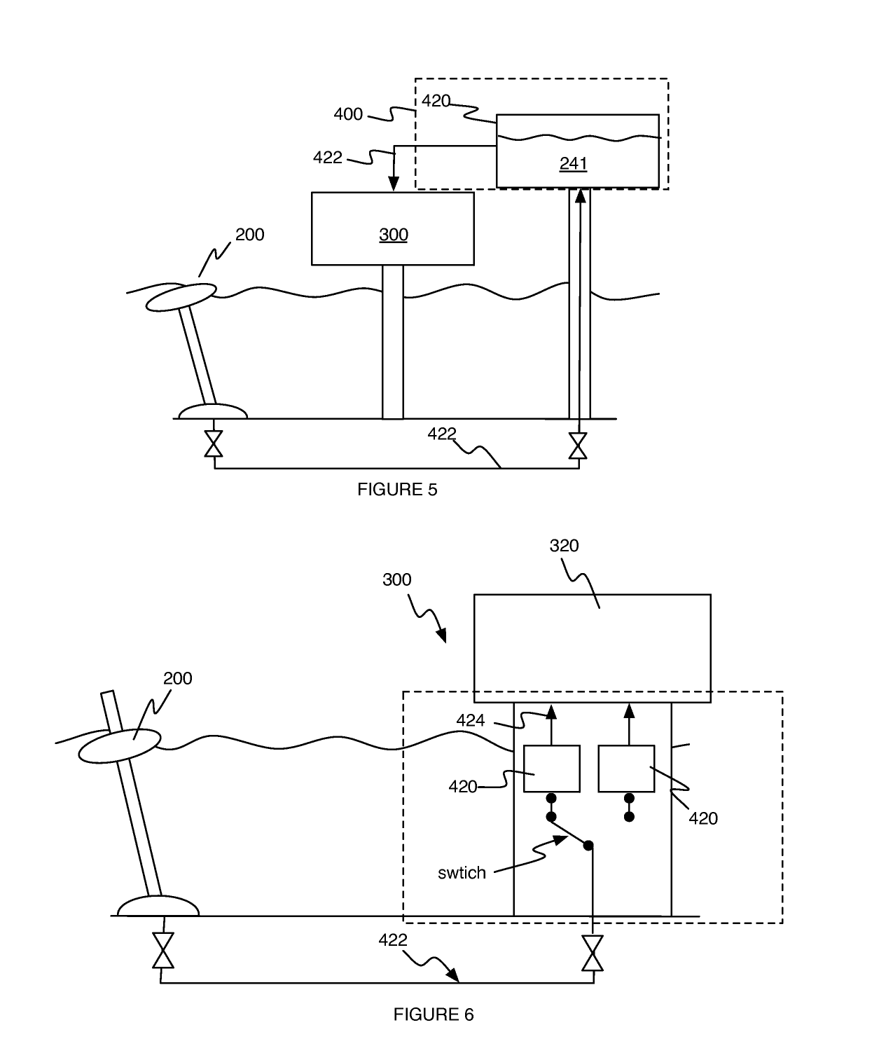

In one embodiment of the system, the electric isolation mechanism 400 includes a reservoir 420 that functions as an intermediary liquid source 10 for the EHD device 300, such that the EHD device 300 can be electrically isolated from the liquid source 10 during EHD system operation. The reservoir 420 preferably functions to retain a volume of charging liquid, wherein the volume of charging liquid is retained in a substantially separate compartment from the liquid source 10. As shown in FIG. 5, the reservoir 420 is preferably selectively connected to the wave power device 200 by a first fluid manifold 422, and can be selectively or statically connected to the EHD device 300 by a second fluid manifold 424. The electric isolation mechanism 400 can additionally include a controller 500 that controls reservoir 420, EHD system, and wave power device operation.

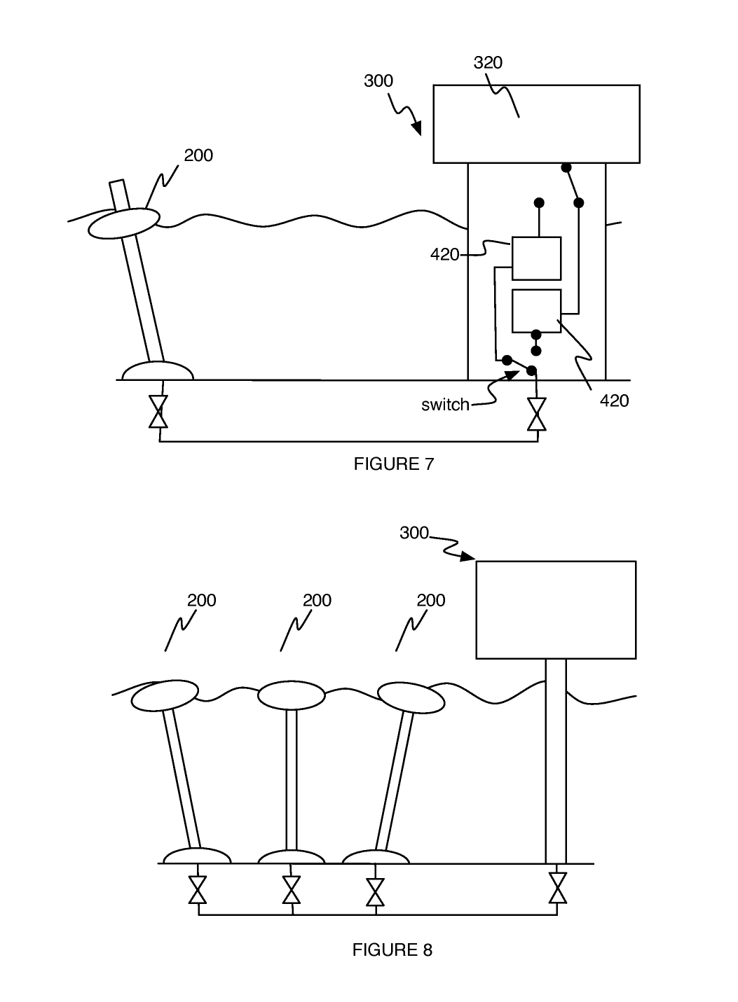

The reservoir 420 is preferably co-located with the EHD device 300, more preferably collocated with the charge source 320 (e.g., on the same support structure as the charge source 320), but can alternatively be located distal from the charge source 320 (e.g., on a separate support structure from the charge source 320, on the wave power device 200, etc.). The reservoir 420 (e.g., the reservoir 420 casing or body) is preferably electrically isolated from the fluid source and/or the EHD device 300 (e.g., droplet charging system). The reservoir 420 is preferably arranged above the charge source 320 (e.g., wherein the charge source 320 is arranged between the reservoir 420 and the liquid source 10) as shown in FIG. 5, wherein hydrostatic pressure preferably feeds fluid to the charge source 320. In this variation, the wave power device(s) is preferably configured to raise the charging liquid from the liquid source 10 up to the reservoir 420. The reservoir 420 can alternatively be arranged below the charge source 320 as shown in FIGS. 5 and 6, or between the charge source 320 and the liquid source 10. The reservoir 420 is preferably pressurized to a pressure above the hydrostatic pressure, wherein the pressure of the liquid within the reservoir 420 feeds fluid to the charge source 320. The wave power device 200 preferably pressurizes the reservoir 420. However, the reservoir 420 pressure can alternatively be substantially equal to the hydrostatic pressure, wherein a secondary pump powered by the load 800 or another energy storage device pumps the charging liquid from the reservoir 420 to the charge source 320. Alternatively, the second fluid manifold 424 can include a wicking or capillary structure that moves liquid from the reservoir 420 to the charge source 320. However, the reservoir 420 can be otherwise arranged relative to the charge source 320, and charging liquid can be otherwise transported from the reservoir 420 to the charge source 320. The reservoir 420 volume is preferably sufficient to supply an EHD device 300 with charging liquid for a given period of time (e.g., several minutes, 1 hour, 1 day, 1 week, etc.), but can alternatively be larger or smaller. The wave EHD system 100 can include one or more reservoir 420s, wherein the reservoir 420s are preferably located at substantially the same distance away from the charge source 320(s) as shown in FIG. 6, but can alternatively be located at various distances away from the charge source 320(s) (e.g., various heights, as shown in FIG. 7).

The reservoir 420 preferably includes a valve 423 that permits fluid flow from the wave power device 200 to the reservoir 420 and prevents fluid flow from the reservoir 420 to the wave power device 200. The valve 423 preferably additionally functions to electrically isolate the wave power device 200 from the reservoir 420 in the supply mode. Alternatively, the reservoir 420 can include a pipe that actuates to switch the wave power device 200 between the connected and disconnected modes. The valve 423 is preferably electrically insulative, and can be made of electrically insulative material such as ceramic, polymer (e.g., rubber), or any other suitable material, but can alternatively have any other suitable property to enable electrical isolation between the liquid source 10 and the reservoir 420. The valve or another mechanism, such as a switch, can additionally or alternatively form an air gap between the reservoir and wave power device. The valve 423 is preferably located within the reservoir 420 or within the junction between the reservoir 420 and the first fluid manifold 422, but can alternatively be located within the first fluid manifold 422. The valve 423 is preferably a passive valve, but can alternatively be an active valve, wherein the valve is placed in the open position during wave power device pumping and in the closed position during pumping cessation. The valve 423 is preferably a one-way valve, but can alternatively be a two-way valve or any other suitable valve. The fluid connection between the reservoir 420 and the second fluid manifold 424 is preferably substantially unobstructed, but can additionally include a second valve 425, wherein the second valve 425 is preferably a passive, one-way valve but can alternatively be substantially similar to the first valve or be any other suitable valve.

In a first variation of the embodiment, the reservoir 420 is operable in a filling mode and a supply mode. In the filling mode, the reservoir 420 is preferably fluidly connected to the liquid source 10 and fluidly disconnected from the EHD device 300. More preferably, the reservoir 420 is fluidly connected to the wave power device 200 and fluidly disconnected from the charge source 320 in the filling mode. In the supply mode, the reservoir 420 is preferably fluidly disconnected from the liquid source 10 and fluidly connected to the EHD device 300. More preferably, the reservoir 420 is fluidly disconnected from the wave power device 200 and fluidly connected to the charge source 320 in the supply mode. However, any other suitable fluid disconnection between the liquid source 10 and the reservoir 420 interior and/or enclosed fluid path between the wave power device 200 and EHD system can be used. The lack of a liquid or electrical connection between the reservoir 420 and the liquid source 10 functions to electrically isolate the EHD device 300 from the liquid source 10, such that EHD particulate charging does not short to the liquid source 10. However, the emitter, reservoir 420, and wave power device 200 can be connected in any other suitable combination in the filling and supply modes.

In a second variation of the embodiment, the reservoir 420 is substantially permanently fluidly connected (e.g., intransiently fluidly connected) to the EHD device 300, and can be selectively fluidly connected to the wave power device 200. The reservoir 420 is operable between a filling mode and a supply mode. The reservoir 420 is preferably operated in the filling mode when the EHD device 300 is in the standby mode, wherein the reservoir 420 is fluidly connected to the wave power device 200. The reservoir 420 is preferably operated in the supply mode when the EHD device 300 is in the operating mode, wherein the reservoir 420 is disconnected from the wave power device 200 (e.g., by shutting off the first valve). However, the emitter, reservoir 420, and wave power device 200 can be connected in any other suitable combination in the filling and supply modes.

In a third variation of the embodiment, the reservoir 420 can be substantially permanently fluidly connected to the EHD device 300 and the wave power device 200. The system is operable between a filling mode and a supply mode. In the filling mode, the EHD device 300 is preferably placed in a standby or off mode (e.g., not charging particles) and the wave power device 200 is preferably operated in a pumping mode, wherein the wave power device 200 pumps liquid from the liquid source 10 to the reservoir 420. In the supply mode, the EHD device 300 is preferably operated in an operating mode (e.g., charging particles) and the wave power device 200 is preferably operated in a standby or disconnected mode, wherein the wave power device 200 ceases fluid pumping to the reservoir 420 when in the standby mode. The wave power device 200 can additionally function to electrically and fluidly isolate the liquid source 10 from the volume of liquid contained within the reservoir 420 when in the standby or disconnected mode. In one example, the wave power device 200 can include a piston pump including valves made of electrically insulative material, such that pumping cessation results in valve sealing, which electrically and fluidly isolates the liquid source 10 from the reservoir 420.

The electric isolation mechanism 400 can include multiple reservoir 420s for each EHD device 300, but can alternatively include a single reservoir 420 for each EHD device 300. The multiple reservoir 420s are preferably connected in parallel but can alternatively be connected in series with the wave power device 200 and the EHD device 300. The multiple reservoir 420s can be selectively connected to the EHD device 300 with a fluid switch or valve control system. Parallel reservoir 420s can isolate and ensure continuous fluid supply to the EHD device 300 as a batch process. Alternatively, non-parallel reservoir 420s or the associated valve(s) can be operated or a switched at a frequency greater than that required to empty each reservoir 420. In this case, the reservoir 420 acts primarily as an electrical isolator rather than a fluid accumulator, and fluid would be supplied to the EHD as an approximately continuous process.

In one example, the wind EHD system includes a first reservoir 420 and a second reservoir 420. The first reservoir 420 is operated in the filling mode in response to second reservoir 420 operation in the supply mode, wherein the first reservoir 420 is fluidly connected to the wave power device 200 and fluidly disconnected to the EHD device 300, and the second reservoir 420 is fluidly disconnected from the wave power device 200 and fluidly connected to the EHD device 300. The first reservoir 420 is operated in the supply mode in response to second reservoir 420 operation in the filling mode, wherein the first reservoir 420 is fluidly disconnected from the wave power device 200 and fluidly connected to the EHD device 300, and the second reservoir 420 is fluidly connected to the wave power device 200 and fluidly disconnected from the EHD device 300. The system preferably disconnects the first reservoir 420 and connects to a second reservoir 420 to the EHD device 300 when the volume of charging liquid within the first reservoir 420 falls below a predetermined threshold.

Alternatively, the wave EHD system 100 can include multiple EHD devices 300 for each reservoir 420, wherein the multiple EHD devices 300 are preferably connected in parallel but can alternatively be connected in series to the reservoir 420. Alternatively, each EHD device 300 can be fluidly connected to a reservoir 420. The multiple reservoir 420s can be fluidly connected to a single wave power device 200, wherein the multiple reservoir 420s are preferably connected in parallel to the wave power device 200 but can alternatively be connected in series to the wave power device 200 or selectively connected to the wave power device 200 by a fluid switch based on the fluid level within the given reservoir 420. Alternatively, multiple wave power devices can be connected to a single reservoir 420, wherein the multiple wave power devices are preferably connected in parallel to the reservoir 420 but can alternatively be connected in series to the reservoir 420 or selectively connected to the reservoir 420 by a fluid switch based on the flow rate from the given wave power device 200. Alternatively, each reservoir 420 can be connected to a single wave power device 200.

In a second embodiment of the system, the electric isolation mechanism 400 can include an electrically insulative insert that is selectively inserted into the connection between the EHD device 300 and the wave power device 200 that electrically and fluidly isolates the EHD device 300 from the wave power device 200. When the wave EHD system 100 includes a reservoir 420, the electrical insulative mechanism can be selectively inserted between the reservoir 420 and the wave power device 200, and/or between the reservoir 420 and the EHD device 300. The electrically insulative mechanism can be a rubber plate, valve, air-gap inducing mechanism (e.g., switch), or any other suitable electrically insulated mechanism that is capable of fluidly isolating the EHD device 300 from the fluid source. However, any other suitable electric isolation mechanism 400 can be used. However, any other suitable electrical isolation mechanism, system, or method that electrically isolates the liquid source 10 from the operating EHD system can be used.

In a third embodiment of the system, the electric isolation mechanism 400 can selectively control the operation modes of the EHD device 300 and the wave power device 200 with a controller 500. The controller 500 preferably operates the wave EHD system 100 between a filling mode and a supply mode. In the filling mode, the controller 500 places the EHD device 300 in a standby mode and operates the wave power device 200 in the pumping mode. In the supply mode, the controller 500 operates the EHD in an operating mode and operates the wave power device 200 in the standby or power supply mode. However, electrical isolation between the charge source 320 and the liquid source 10 can be achieved in any other suitable manner.

The wave EHD system 100 can additionally include one or more sensors 600 that measure system parameters, such as ambient environmental parameters, EHD device operational parameters, wave power device operational parameters, or reservoir 420 parameters. The wave EHD system 100 can additionally include a controller 500 connected to the sensor 600 that controls the EHD operational parameters based on the sensor 600 measurements. The controller 500 preferably controls the EHD parameters to increase the energy extraction efficiency, but can alternatively control the EHD operational parameters to maintain a given power output, obtain a target power output, or obtain any other suitable output parameter. The target EHD operational parameters can be automatically determined based on the sensor 600 measurements, received from a remote source (e.g., received from the transmission grid), or determined in any other suitable manner. The system can include one or more sensors 600 that measure wind parameters (e.g., wind velocity, direction, temperature, humidity, etc.), power output parameters, or any other suitable wave EHD system 100 operation parameter. The system can additionally or alternatively include one or more sensors 600 that measure fluid parameters of the fluid from the fluid source, such as the fluid temperature, salinity, pH, dissolved oxygen, turbidity, hardness, suspended sediment, or any other suitable fluid parameter. The system can additionally or alternatively include one or more sensors 600 that measure wave power device operational parameters, such as fluid pressure, pumping rate, amount of power extracted, flow rate, or any other suitable parameter. The system can additionally or alternatively include one or more sensors 600 that measure reservoir 420 parameters, such as liquid level, internal pressure, temperature, or any other suitable parameter. The controller 500 can adjust one or more particle parameters, applied electric field parameters, position parameters, or any other suitable parameter. Examples of parameters that can be adjusted include the amount of charge imparted on each droplet, the size of each droplet, the polarity of each droplet, the strength of the applied electric field, the strength of the field shaper field, the distance of the EHD device 300 from electrical ground (e.g., the surface of the liquid source 10), the connection state of the load 800, the rate of liquid provision to the EHD device 300, the EHD device 300 position relative to the wind, the wave power device position relative to the wind and/or waves, or any other suitable EHD operational parameter. The EHD operational parameter can be determined empirically (e.g., incrementally adjusted until a target output parameter is achieved), adjusted to a predetermined value (e.g., based on the sensor 600 measurement), or determined in any other suitable manner.

The wave EHD system 100 can additionally include a wind element that maintains the EHD position (e.g., lateral and/or angular position) relative to the wind. The wind element is preferably a sail that passively adjusts the EHD position in response to changes in the wind parameters (e.g., velocity, direction, etc.), but can alternatively be a motor coupled to a sensor 600 that actively adjusts the EHD position based on the sensor 600 measurements. The sensor 600 can measure wind parameters (e.g., wind velocity, direction, temperature, humidity, etc.), power output parameters, or any other suitable wave EHD system 100 operation parameter. The EHD position can be determined empirically (e.g., incrementally adjusted until a position resulting in maximum power output is determined), adjusted to a predetermined position (e.g., wherein the EHD position is predetermined for a given wind direction and velocity), or determined in any other suitable manner.

In operation, a method of energy extraction from a fluid stream 20 includes pumping liquid from the liquid source 10 (e.g., the ocean or another body of water) to the EHD device 300, more preferably the charge source 320, with a wave power device 200 and introducing a charged droplet of the pumped liquid 241 into a fluid stream 20 (e.g., a wind stream) with the EHD device 300. The method can additionally include electrically isolating the charge source 320 from the liquid source 10.

Pumping a volume of liquid from the liquid source 10 to the EHD device 300 preferably includes pumping the liquid from the liquid source 10 using wave power harnessed by the wave power device 200. Pumping the volume of liquid can include pumping the liquid from the wave power device 200 to a reservoir 420, wherein liquid is supplied to the EHD device 300 from the reservoir 420. The liquid can be actively pumped from the reservoir 420 to the EHD device 300, driven by hydrostatic pressure, driven by the pressure generated within the reservoir 420 by the liquid pumped by the wave power device 200, or supplied to the EHD device 300 in any other suitable manner.

Introducing a charged droplet into the fluid stream 20 preferably includes generating a droplet of the pumped liquid 241 and charging the droplet to a first polarity. Introducing a charged droplet into the fluid stream 20 can include introducing a plurality of charged particles of a single polarity into the fluid stream 20 (positive or negative), or introducing multiple charged particles of a first and second polarity into the fluid stream 20 (positive and negative). The droplet can be simultaneously charged and generated (e.g., as described above), or can be generated then charged (e.g., as described above). Charging the droplet can additionally include extracting electrical energy from motion of the liquid source 10 using the wave power device 200 and using the extracted electric power 251 to charge the droplet. The extracted electrical power can additionally be used to power the sensors 600 and controller 500(s) of the wave EHD system 100.

Electrically isolating the charge source 320 from the liquid source 10 functions to isolate the liquid supply to the charge source 320 from the liquid source 10 to prevent charge source 320 shorting to the liquid source 10. Electrically isolating the charge source 320 from the liquid source 10 can include fluidly connecting the charge source 320 to a reservoir 420, wherein the reservoir 420 is fluidly disconnected from the liquid source 10 or wave power device 200. Alternatively, electrically isolating the charge source 320 from the liquid source 10 can include placing the wave power device 200 in the standby mode in response to EHD operation in the operating mode, and placing the wave power device 200 in the pumping mode in response to EHD operation in the standby mode. A charge source 320 is preferably always electrically isolated from the liquid source 10, but can alternatively be electrically isolated from the liquid source 10 in response to occurrence of a supply event or EHD device operation in the operating mode, or in response to the occurrence of any other suitable event. However, the charge source 320 can be otherwise fluidly isolated from the liquid source 10. Fluid connection and disconnection between wave EHD system 100 components preferably includes opening and closing valves located along the fluid manifolds or paths connecting the components, respectively, but can alternatively include actuating pipes or otherwise fluidly connecting and disconnecting the components.

The method can additionally include extracting power from the EHD device 300, which functions to extract power from charged particle 101 displacement. Extracting power from the EHD device 300 can include inducing an electric field, fluid stream 20 drag on the charged droplet at least partially opposed by electric field drag on the charged droplet. Inducing an electric field can include introducing the plurality of charged droplets of the same polarity into the fluid stream 20 and collecting opposing charges at an upstream collector, such as the charge source 320. For example, positively charged droplets can be introduced into the wind and negative charges can be collected. Extracting power from the EHD device 300 can additionally include collecting the introduced charges at a downstream collector 700, such as the liquid source 10 or a separate downstream component, such as a conductive mesh. Extracting power from the EHD device 300 can additionally include using a load 800 electrically connected between the charge source 320 and the downstream collector 700 to facilitate charge flow (e.g., induce a current) and convert the charge displacement into electric power.

The method can additionally include monitoring the system parameters and adjusting the wave EHD system operating parameters to increase efficiency. The system parameters that can be measured are preferably those disclosed above, but can alternatively be any other suitable parameters. The wave EHD system operating parameters that are adjusted are preferably those disclosed above, but can alternatively be any other suitable parameters.

As a person skilled in the art will recognize from the previous detailed description and from the figures and claims, modifications and changes can be made to the preferred embodiments of the invention without departing from the scope of this invention defined in the following claims.

We claim:

1. A system for energy extraction from a fluid stream comprising:
a wave pump configured to pump a volume of liquid from a liquid source in response to wave motion of the liquid source; and
a charge source, fluidly connected to the volume of fluid, that emits a charged droplet of the volume of fluid into the fluid stream, the charged droplet having a first polarity.

2. The system of claim 1, further comprising an electric isolation mechanism that electrically isolates the liquid source from the charge source.

3. The system of claim 2, wherein the electric isolation mechanism comprises a mechanism configured to selectively form an air gap between the wave pump and charge source.

4. The system of claim 3, wherein the electric isolation mechanism comprises a reservoir configured to receive the volume of fluid, the reservoir is operable between:
a filling mode, wherein the reservoir is fluidly connected to the wave pump and fluidly isolated from the charge source; and
a supply mode, wherein the reservoir is fluidly connected to the charge source and fluidly isolated from the wave pump.

5. The system of claim 4, wherein the electric isolation mechanism comprises a first and a second reservoir, the first reservoir operable between:
the filling mode in response to second reservoir operation in the supply mode; and
the supply mode in response to second reservoir operation in the filling mode.

6. The system of claim 1, further comprising:
a sensor that monitors a first system parameter; and
a controller that adjusts a second system parameter to increase energy extraction efficiency in response to a change in the first system parameter.

7. The system of claim 1, further comprising a load electrically connected between the charge source and a downstream collector configured to collect charges emitted with the charged droplets.

8. The system of claim 1, wherein the charge source comprises a droplet generator fluidly connected to the wave pump and a droplet charger.

9. The system of claim 8, wherein the wave pump further comprises an electrical energy extractor configured to extract electrical energy from waves on the fluid source, the electrical energy extractor electrically connected to the droplet charger.

10. A method for energy extraction by a system from a fluid stream, comprising:
pumping liquid from a liquid source to an emitter using a wave power device fluidly connected to the liquid source using power harnessed from motion of the liquid source; and
introducing a charged droplet of the pumped liquid into the fluid stream from the emitter, the charged droplet having a first polarity.

11. The method of claim 10, further comprising electrically isolating the emitter from the liquid source prior to introducing a charged droplet into the fluid stream.

12. The method of claim 11, wherein electrically isolating the emitter from the liquid comprises ceasing liquid pumping from the liquid source.

13. The method of claim 12, wherein pumping liquid from the liquid source comprises pumping liquid from the liquid source in response to halting charged droplet introduction into the fluid stream.

14. The method of claim 11, wherein pumping liquid from a liquid source to an emitter using a wave power device fluidly connected to the liquid source comprises pumping the liquid from the liquid source to a reservoir; and electrically isolating the emitter from the liquid source comprises fluidly disconnecting the pumped liquid within the reservoir from the liquid source.

15. The method of claim 14, wherein introducing a charged droplet of the pumped liquid further comprises fluidly connecting the reservoir to the emitter in response to reservoir disconnection from the liquid source.

16. The method of claim 14, wherein electrically isolating the emitter from the liquid source is in response to a liquid level in the reservoir exceeding a threshold level.

17. The method of claim 10, further comprising:
monitoring an environmental parameter;
changing a system parameter in response to changes in the environmental parameter.

18. The method of claim 10, further comprising:
extracting electrical energy from motion of the liquid source using the wave power device;
wherein introducing the charged droplet of the first polarity comprises generating the droplet from the pumped fluid and charging the droplet with the extracted electrical energy.

19. The method of claim 10, further comprising extracting power from charged particle displacement using a load electrically connected between the emitter and a downstream collector that collects the charged droplets.

20. The method of claim 10, further comprising inducing an electric field, fluid stream drag on the charged droplet at least partially opposed by electric field drag on the charged droplet, wherein introducing the charged droplet comprises introducing a plurality of charged droplets of the first polarity into the fluid stream, wherein introducing the charged droplets induces the electric field.
